(19) United States
(12) Patent Application Publication
(10) Pub. No.: US 2005/0060208 A1
(43) Pub. Date: Mar. 17, 2005

(54) Method for optimizing insurance estimates utilizing Monte Carlo simulation

(76) Inventor: Raymond J. Gianantoni, Wilbraham, MA (US)

Correspondence Address: MCCORMICK, PAULDING & HUBER LLP, CITY PLACE II, 185 ASYLUM STREET, HARTFORD, CT, 06103, US

(21) Appl. No.: 10/920,105

(22) Filed: Aug. 17, 2004

Related U.S. Application Data
(60) Provisional application No. 60/503,543, filed on Sep. 17, 2003.

(51) Int. Cl. G06F 7/60; G06F 17/10; G06F 17/60

(52) U.S. Cl. 705/4; 703/2

(57) ABSTRACT

A method for optimizing insurance estimates utilizing Monte Carlo simulation includes the steps of ascertaining the total number of potential insured units and obtaining a quote for full insurance based on the total number of potential insured units. The method further includes creating a model of total costs of self insurance for the potential insured units, obtaining data distributions for all variables in the model of total costs of self insurance and running a Monte Carlo simulation on the model a preselected number of iterations. A range of range of possible total costs of self-insurance and the probabilities of such costs is then obtained facilitating a selection between full insurance and self-insurance.

### CROSS REFERENCE TO RELATED APPLICATIONS

This application claims the benefit of U.S. Provisional Patent Application Ser. No. 60/503,543 filed on Sep. 17, 2003, entitled “USE OF MONTE CARLO SIMULATION TO PREDICT RESULTS ON HEALTH INSURANCE,” herein incorporated by reference in its entirety.

### FIELD OF THE INVENTION

The present invention relates to a system and method for optimizing insurance estimates. Specifically, the present invention involves a system and method for calculating the costs of self-insurance and the probability of such costs using Monte Carlo simulation to assist employers in selecting an appropriate type of insurance.

### BACKGROUND OF THE INVENTION

Employers obtain health insurance funding in one of two ways. Employers may be either fully insured or self-insured. Fully insured employers pay a monthly premium to an insurance carrier to cover their employees' medical expenses. Being fully insured offers employers several benefits including known premiums that may be included in a budget, minimal financial risk and ease of plan administration.

Many employers, however, choose to self-insure rather than purchase group insurance plans to minimize their expenses. These employers typically set aside funds from which employees and their families are reimbursed for their medical expenses. Self-insured employers usually hire an administrator to process their employees' claims. While self-insurance is often an excellent cost-saving measure, it exposes employers to a high level of financial risk. If an employee incurs unexpectedly high medical expenses, an employer's medical reimbursement funds may be exhausted. To reduce the financial risk, employers obtain stop-loss insurance, which reimburses employers for medical expenses that exceed a certain deductible threshold, often referred to as a cap level.

There are two basic types of stop loss insurance; aggregate and individual/specific stop loss. Aggregate stop-loss insurance reimburses an employer when all claims exceed an agreed upon threshold or cap, typically described as a monthly amount per employee and employee with family. The cap is typically a percentage, e.g., 120% or 125%, of what the carrier expects the claims will be.

With specific stop loss insurance, the carrier reimburses the employer when claims for an individual exceed a specified amount or cap in a plan year. The carrier reimburses the employer for the remainder of the plan year. Specific stop-loss insurance has different rates for single employees and for families. The rates are lower the higher the cap at which the carrier begins reimbursing the employer.

While stop-loss insurance reduces financial risk for self-insured employers, it is an added expense that must be considered when determining the whether self-insurance is appropriate.

In light of the above, employers contemplating self-insurance must perform a detailed analysis to determine whether the costs of this type of insurance are greater or less than the costs of full insurance. Performing such an analysis, however, is often difficult as stop-loss insurance carriers do not provide information regarding the projected total annual costs of self-insurance to the employer and do not compare such data to the annual costs of full insurance. Stop-loss insurance carriers simply quote prices for different cap levels, e.g., $50,000, $60,000 or $70,000 leaving the employer to determine whether self-insurance is the best option.

In light of the above, there exists a need for a source of the total projected annual costs of self-insurance and the probability of such costs so that employers can determine whether self-insurance is appropriate. The present invention fulfills these needs and more.

### SUMMARY OF THE INVENTION

It is an object of the present invention to provide a system and method of optimizing insurance estimates that offers potential insurance purchasers information regarding the amount and probability of total annual insurance costs from which they can make an informed decision as to an appropriate type of insurance coverage.

It is another object of the present invention to provide a system and method of optimizing insurance estimates that provides employers with projected total annual costs of self-insurance and the probabilities of such costs through a Monte Carlo simulation and compares the projected costs to the cost of full-insurance so that employers may make an informed decision as to the appropriate type of insurance.

A method for optimizing insurance estimates utilizing statistical simulation according to the present invention includes the steps of: ascertaining the total number of potential insured units; obtaining a quote for full insurance based on the total number of potential insured units; creating a model of total costs of self insurance for the potential insured units; obtaining data distributions for all variables in the model of total costs of self insurance; running a statistical simulation on the model a preselected number of iterations; and obtaining a range of possible total costs of self insurance and the probabilities of such costs.

These and other objects and advantages of the present invention will become readily apparent upon further review of the following drawings and specification.

### BRIEF DESCRIPTION OF THE DRAWINGS

FIG. 1 is a schematic of one possible system according to the present invention.

FIG. 2 is a flowchart illustrating the steps of a method according to the present invention.

FIG. 3 is a table illustrating the projected total annual costs for self-funded plans at various probability levels and the saving over fully insured plans at these levels.

FIG. 4 is a spreadsheet illustrating an implementation of a method of the present invention.

### DETAILED DESCRIPTION OF THE PREFERRED EMBODIMENT

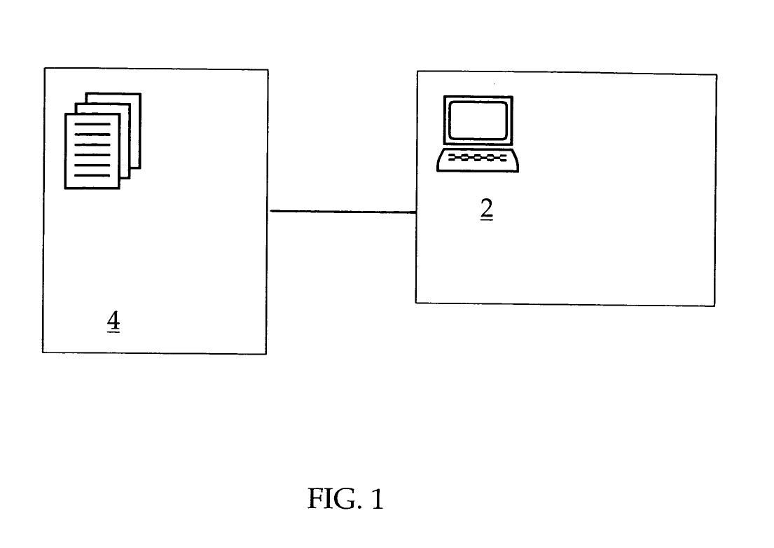

As shown schematically in FIG. 1, a system in accordance with an embodiment of the present invention includes a computer 2, and at least one database 4 containing data representing the variables used to calculate projected total annual costs of self-insurance for an employer 4. As discussed in greater detail below, the computer 2 contains software that utilizes Monte Carlo analysis to calculate projected total annual costs for self insurance, as well as the probabilities of such costs, from data in the database 4. As will be appreciated, the database 4 may be resident on the computer 2 or may be accessible via a network such as the Internet.

The database 4 contains data representing the variables used to calculate projected total annual costs of self-insurance. These variables may include quantifiable factors such as administrative expenses to administer a self-insured plan, the cost of stop-loss insurance at specific cap levels, broker commissions, demographics of the group of potential insureds, location of employer and net work cost savings.

The database may also include variables such as the number of expected claims and aggregate maximum and shock claims i.e., claims that are 50% or more of the specific limit. The number of expected claims might be obtained from historical insurance industry loss statistics. The statistics typically include age, sex, geographic location, occupation and other relevant statistics of individual loss incurring insureds at well as the amount of each loss. The statistics also include whether the loss incurring insured was a single insured or family insured. Third party companies typically compile these statistics and they may be stored in a database. As will be appreciated, the loss statistics used to calculate the expected claims may be carrier specific or may be general industry statistics and may be an annual compilation or may represent a greater time period.

The software on the computer 2 can include statistical software programs capable of performing a Monte Carlo simulation. These programs include statistical software such as SAS®, Systat® and Crystal Ball®. Such software programs also include spreadsheet software such as Microsoft Excel®.

As will be appreciated, Monte Carlo simulation is a quantitative risk analysis technique. Monte Carlo simulation involves repeatedly executing a model that contains multiple variables to be analyzed. Each execution of the model is referred to as iteration. Each variable in the model is represented by a probability distribution of possible values. During each iteration, values from the probability distributions are randomly selected. A simulation provides a range of possible outcomes that could occur and the likelihood of any outcome occurring.

The above application of Monte Carlo simulation to project the costs of self-insurance is an important aspect of the present invention. By utilizing Monte Carlo simulation, all costs can be assessed to predict the total costs of self-insurance and the probability of such costs. These costs can then be compared to the annual costs of full insurance to determine which type of insurance is most appropriate. Currently, this information is not provided to employers that are in the process of selecting insurance.

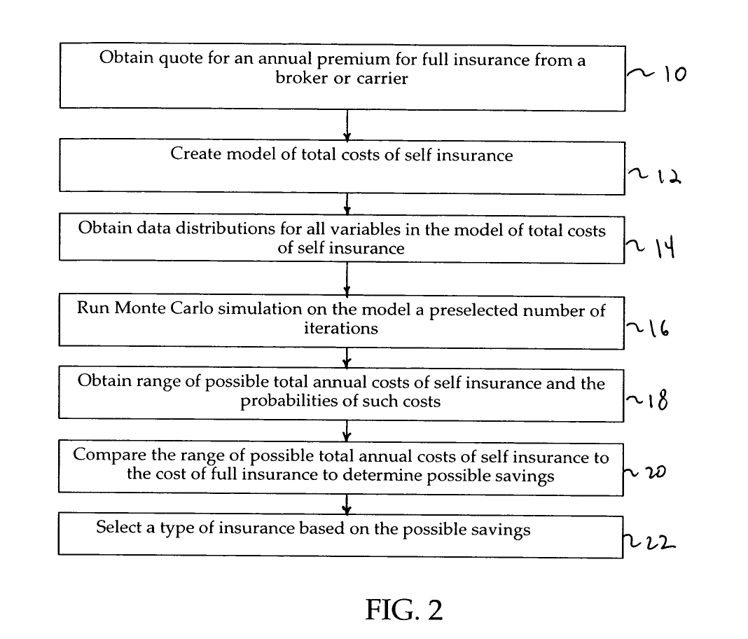

FIG. 2 is a flow chart indicating steps of a method of the present invention in optimizing insurance estimates utilizing Monte Carlo simulation. As noted at 10, the initial step is obtaining a quote for an annual premium for full insurance from a carrier. As will be appreciated, the quote may be obtained from a broker or directly from the carrier. To further facilitate selecting the most appropriate type of insurance, several quotes may be obtained from different carriers. The annual costs of full insurance provide a baseline against which the projected total costs of self-insurance are compared.

After the employer has obtained quotes for full insurance, a model of the total costs of self-insurance must be created as noted at 12. This step involves determining the specific variables to be included in calculating the costs. As mentioned previously, these variables may include administrative expenses, the cost of stop-loss insurance at specific cap levels, broker commissions, demographics of the group of potential insureds, location of employer and expected losses. Once the variables have been determined, they may be expressed as a model such as y=f(x¹, x², X³, x⁴) where y is the total cost of self-insurance and the variables are x¹-x⁴.

After the model of the total costs has been determined, data distributions for all of the variables in the model must be obtained as noted at 14. If the distributions are not known, a maximum and minimum value for a variable will suffice. As will be appreciated, certain variables are likely to have existing data, such as historical industry loss data used to calculate expected losses. Depending on the software used, existing data may be fit into distributions before the simulation is implemented.

As noted at 16, once the distributions and/or maximum and minimum values have been obtained, the Monte Carlo simulation is implemented. This is accomplished by randomly selecting a value from the distribution of values for each of the variables in the model. This may be accomplished by randomly selecting a value from an existing distribution or, if the distribution does not preexist, using a uniform distribution created through the use of a random number generator. To generate a random number for such variables, the maximum and minimum values of the variable must be obtained. The generator will then randomly select a number within the maximum and minimum values. As will be appreciated, this process may utilize a uniform distribution or other distribution such as a Gaussian distribution.

The random selection of values from the variables in the model is repeated a preselected number of iterations. The number of iterations is preferably 10,000, although other values are possible.

As noted at 18, after the preselected iterations have been run, the range of possible outcomes and the probabilities of such outcomes are obtained. In other words, a range of possible total annual costs of self-insurance is obtained along with the probabilities of the possible costs.

As recorded at 20, once the range of possible total costs and probabilities has been obtained, this data is compared to the fixed annual costs of full insurance obtained from the quotes. That is, the projected costs of self-insurance at the probability levels obtained from the simulation are subtracted from the cost of full insurance to determine possible savings.

After the possible savings have been determined, the employer can use this information to select between self-insurance or full insurance, as noted at 22.

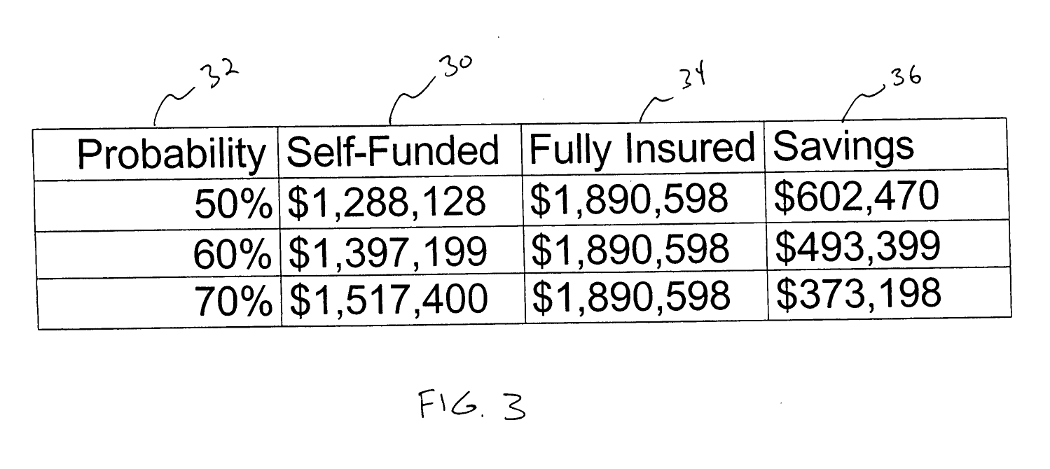

An example of the results of the above process is shown in FIG. 3. For a self-insured plan, also referred to as self-funded plan, the possible total costs 30 are $1,288,128; $1,397,199 and $1,517,400 at probabilities 32 of 50, 60 and 70% respectively. Therefore, in this example, it is more likely that the costs of self-insurance will be higher rather than lower. The possible costs of the self-funded plan are then subtracted from the fixed costs for full insurance 34 obtained through the quotes to determine possible savings 36.

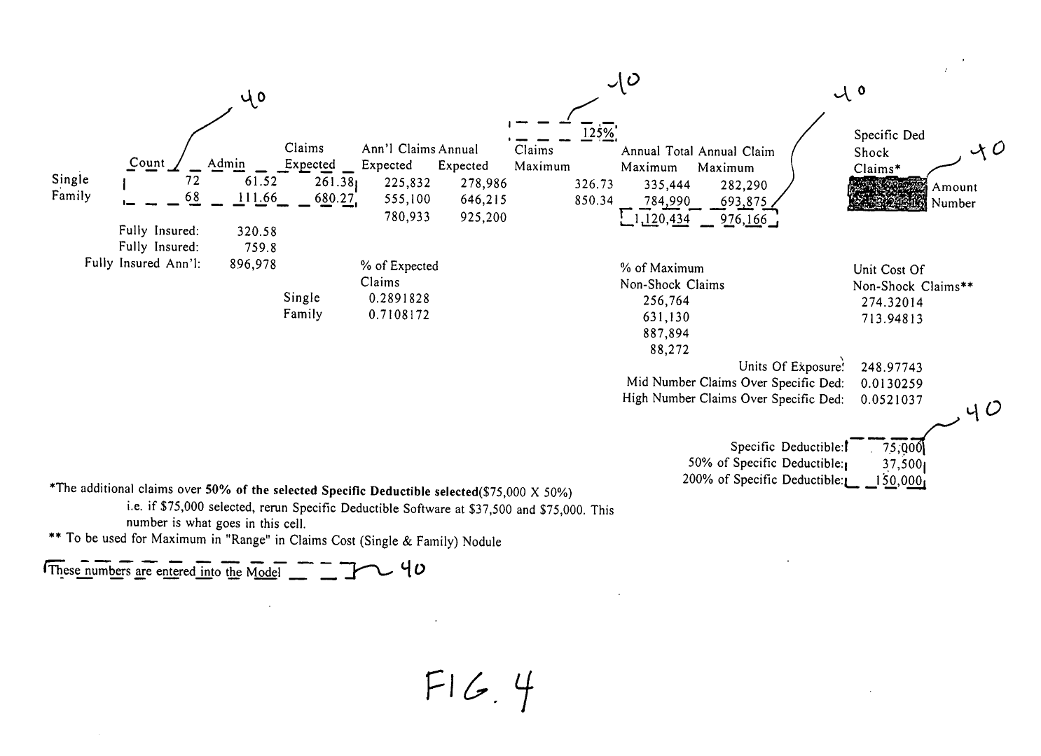

FIG. 4 illustrates an implementation of a method of the present invention utilizing Microsoft Excel®. In the implementation of FIG. 4, the model contains multiple variables 40. These include the number of potential insured units, referred to as “counts” and the claims expected per 1000 insured units.

Although the present invention has been described with reference to preferred embodiments, it will be appreciated by those of ordinary skill in the art, that various modifications to this invention may be made without departing from the spirit and scope of the invention.

1. A method for optimizing insurance estimates utilizing statistical simulation comprising the steps of:
ascertaining the total number of potential insured units;
obtaining a quote for full insurance based on the total number of potential insured units;
creating a model of total costs of self-insurance for the potential insured units;
obtaining data distributions for all variables in the model of total costs of self-insurance;
running a statistical simulation on the model a preselected number of iterations; and
obtaining a range of possible total costs of self-insurance and the probabilities of such costs.

2. The method for optimizing insurance estimates of claim 1 further comprising the step of:
comparing the range of possible total annual costs of self-insurance to the quoted cost of full insurance to determine possible savings.

3. The method for optimizing insurance estimates of claim 2 further comprising the step of:
selecting a type of insurance based on the possible savings.

4. The method for optimizing insurance estimates of claim 1, wherein:
said potential insured units include individual and family potential insured units.

5. The method for optimizing insurance estimates of claim 4, wherein:
said variables include the administrative expenses to administer a self-insurance plan, the cost of stop-loss insurance at specific cap levels, broker commissions, demographics of the group of potential insured units and the location of employer.

6. The method for optimizing insurance estimates of claim 5, wherein the statistical simulation is a Monte Carlo simulation.

7. The method of optimizing insurance estimates of claim 6, wherein the preselected number of iterations is about 10,000 iterations.

8. The method of optimizing insurance estimates of claim 1, wherein said
data distributions for all variables in the model of total costs of self-insurance are either preexisting data distributions or are generated from a maximum and minimum value for a variable.

9. A method for optimizing insurance estimates utilizing Monte Carlo simulation comprising the steps of:
ascertaining the total number of individual and family potential insured units;
obtaining a quote for full insurance based on the total number of potential insured units;
creating a model of total costs of self-insurance for the potential insured units;
obtaining data distributions for all variables in the model of total costs of self insurance, said data distributions being either a pre-existing distribution or generated from a maximum and minimum value for a variable;
running a Monte Carlo simulation on the model a preselected number of iterations; and
obtaining a range of possible total costs of self-insurance and the probabilities of such costs.

10. The method of optimizing insurance estimates of claim 9, wherein the preselected number of iterations is about 10,000 iterations.

11. The method for optimizing insurance estimates of claim 10, wherein:
said variables include the administrative expenses to administer a self-insurance plan, the cost of stop-loss insurance at specific cap levels, broker commissions, demographics of the group of potential insured units and the location of employer.

12. The method for optimizing insurance estimates of claim 9 further comprising the step of:
comparing the range of possible total annual costs of self-insurance to the quoted cost of full insurance to determine possible savings.

13. The method for optimizing insurance estimates of claim 12 further comprising the step of:
selecting a type of insurance based on the possible savings.

14. A method for optimizing self-insurance estimates utilizing Monte Carlo simulation comprising the steps of:
ascertaining the total number of individual and family potential insured units;
obtaining a quote for full insurance based on the total number of potential insured units;
creating a model of total costs of self-insurance for the potential insured units;
obtaining data distributions for all variables in the model of total costs of self insurance, said data distributions being either a pre-existing distribution or being generated from a maximum and minimum value for a variable;
running a Monte Carlo simulation on the model a preselected number of iterations, said preselected number being about 10,000 iterations;
obtaining a range of possible total costs of self-insurance and the probabilities of such costs;
comparing the range of possible total annual costs of self insurance to the quoted cost of full insurance to determine possible savings; and
selecting either self-insurance or full insurance based on the possible savings.

15. The method for optimizing insurance estimates of claim 14, wherein: said variables include the administrative expenses to administer a self-insurance plan, the cost of stop-loss insurance at specific cap levels, broker commissions, demographics of the group of potential insured units and the location of employer.
